(19) United States
(12) Patent Application Publication
(10) Pub. No.: US 2026/0333557 A1
(43) Pub. Date: Oct. 22, 2026

(54) OPTICAL DETECTION OF ARCING EVENTS IN AN X-RAY TUBE

(71) Applicant: KONINKLIJKE PHILIPS N.V., EINDHOVEN (NL)

(72) Inventors: Peter Forthmann, SANDESNEBEN (DE); Christoph Günther Leussler, HAMBURG (DE); Oliver Lips, HAMBURG (DE); Alexander Ulrich Douglas, VESSEM (NL); Aleksei Agafonov, EINDHOVEN (NL); Gereon Vogtmeier, AACHEN (DE); Steffen Weiss, HAMBURG (DE)

(21) Appl. No.: 19/110,467

(22) PCT Filed: Sep. 8, 2023
(86) PCT No.: PCT/EP2023/074729

§ 371 Date: Mar. 11, 2025

(30) Foreign Application Priority Data
Sep. 15, 2022 (EP) 22195883.8

(51) Int. Cl. H05G 1/54; H05G 1/02; H05G 1/04

(52) U.S. Cl. CPC H05G 1/54; H05G 1/025; H05G 1/04

(57) ABSTRACT

An X-ray tube (110) includes: a vacuum-containing envelope (120), a housing (130), a cooling fluid (140), and an optical sensor (150). The vacuum-containing envelope (120) and the housing (130) are separated by a space, and the space is filled by the cooling fluid (140). The optical sensor (150) is arranged to detect optical arcing radiation (160) passing tangentially around the vacuum-containing envelope through the cooling fluid-filled space, and which optical arcing radiation is generated within the vacuum-containing envelope in response to an arcing event (170).

### FIELD OF THE INVENTION

The present disclosure relates to the optical detection of arcing events in an X-ray tube. An X-ray tube, and a system, are provided.

### BACKGROUND OF THE INVENTION

X-ray tubes are used to generate X-ray radiation in various application fields. For instance, X-ray tubes are used in the fields of medical imaging systems, non-destructive testing, materials characterisation, and also in the security field such as in baggage inspection.

X-ray tubes include a vacuum-containing envelope, within which is disposed an anode target, and a cathode. In-use, the cathode is heated, causing it to liberate electrons. The electrons are accelerated towards an anode, or “anode target” under the influence of an electric field. The electrons are stopped by the anode target, which results in the emission of a continuous spectrum of “Bremsstrahlung” X-ray radiation. Spectral lines of characteristic X-ray radiation may also be emitted as a result of the electrons knocking orbital electron out of the inner electron shell of the target atoms. The X-ray radiation is emitted by the X-ray tube in the form of a beam, and which beam is then used in the various application fields mentioned above.

Occasionally, an X-ray tube may exhibit an effect known as arcing. During its manufacture, the vacuum-containing envelope of an X-ray tube is sealed with a pressure that may be as low as 10⁻⁸ mbar. This provides an undisturbed path for the electrons passing from the cathode to the anode. An arcing event occurs when internal ionization occurs within the X-ray tube. This leads to internal discharges between metal structures within the vacuum-containing envelope, typically in regions of high electric field strength, such as between the cathode and the anode. The internal discharges appear in the form of a pulse of optical arcing radiation.

Arcing may arise for various reasons. In new X-ray tubes, arcing may occur as a consequence of incomplete degassing procedures. Such arcing events can occur temporarily, and may have little impact on the long term performance of the X-ray tube. In older X-ray tubes, thermal stresses induced in the materials within the vacuum-containing envelope can result in imperfections such as cracks on the surface of the anode target, and materials can also become deposited on the inner surface of the vacuum-containing envelope. Both of these effects can contribute to arcing in older tubes, and can lead to a catastrophic failure of the X-ray tube. Arcing can also occur within the X-ray tube for other reasons.

Irrespective of its origins, arcing within an X-ray tube leads to a disruption of workflow. For instance, in medical imaging systems, if arcing occurs during a scan, it can result in image artifacts in the resulting medical images. If the arc is relatively small, the image artifacts are typically minor, and in which case the resulting image may be clinically acceptable. However, if the arc is relatively large, the scan may need to be repeated. This leads to an increase in X-ray dose to a subject. Ultimately, a large arc may result in the catastrophic failure of the X-ray tube. In this case, the tube will need to be replaced, which risks incurring a delay whilst the imaging system is inoperable.

The ability to detect arcing events in an X-ray tube can provide information that is useful in guiding the course of action to be taken after an arc occurs. For instance, if the arc is relatively small, it may be possible to continue using the X-ray tube. By contrast, if the arc is relatively large, it may be necessary to plan a maintenance operation on the X-ray tube, or to plan the replacement of the X-ray tube. By building-up a history of such arcing events, it may also be possible to predict an expected time of the X-ray tube's failure, and therefore plan the tube's replacement prior to the failure materialising.

A document WO 2022/053381 A1 relates to an optical monitoring system for monitoring an X-ray tube. The optical monitoring system comprises: at least one optical sensor configured to detect first signals of a first optical parameter and second signals of a second optical parameter thereby generating measurement data, wherein the first and second optical parameters are selected from the group comprising plasma glow, discharges, micro-discharges, arcs, X-ray fluorescence, line emissions, wherein the first and second optical parameters are different from each other, the optical monitoring system further comprising a computing unit configured to transmit, to a remote system external of optical monitoring system and the X-ray tube, said generated measurement data and/or a result of an analysis of measurement data carried out by the computing unit.

However, there remains a need for improvements in the detection of arcing events in X-ray tubes.

### SUMMARY OF THE INVENTION

According to one aspect of the present disclosure, an X-ray tube is provided. The X-ray tube includes a vacuum-containing envelope, a housing, a cooling fluid, and an optical sensor. The vacuum-containing envelope and the housing are separated by a space, and the space is filled by the cooling fluid. The optical sensor is arranged to detect optical arcing radiation passing tangentially around the vacuum-containing envelope through the cooling fluid-filled space, and which optical arcing radiation is generated within the vacuum-containing envelope in response to an arcing event.

Some X-ray tubes include a cooling fluid-filled space between the vacuum-containing envelope and the housing. The cooling fluid is used to remove heat that is generated as a side-effect of the X-ray radiation, and which might otherwise damage the X-ray tube. The inventors have observed that optical arcing radiation that is generated within the vacuum-containing envelope, intercepts the cooling fluid-filled space between the vacuum-containing envelope and the housing. The inventors have also observed that the cooling fluid-filled space serves as a light guide that confines some of the intercepted optical arcing radiation to the cooling fluid-filled space. Some of the optical arcing radiation that is intercepted, propagates tangentially around the vacuum-containing envelope through the cooling fluid-filled space. By arranging the optical sensor such that it detects optical arcing radiation passing tangentially around the vacuum-containing envelope through the cooling fluid-filled space, it is provided that the optical sensor detects a significant amount of the optical arcing radiation. Consequently, the optical sensor has a high sensitivity to arcing events.

Further aspects, features, and advantages of the present disclosure will become apparent from the following description of examples, which is made with reference to the accompanying drawings.

### BRIEF DESCRIPTION OF THE DRAWINGS

FIG. 1 is a schematic diagram illustrating an example of an X-ray tube 110 including an optical sensor 150, in accordance with some aspects of the present disclosure.

FIG. 2 is a schematic diagram illustrating an example of an X-ray tube 110 including an optical sensor 150 and an optical window 190, in accordance with some aspects of the present disclosure.

FIG. 3 is a schematic diagram illustrating an example of an X-ray tube 110 including an optical sensor 150, an optical window 190, and an optical collector 200, in accordance with some aspects of the present disclosure.

FIG. 4 is a schematic diagram illustrating an example of an X-ray tube 110 including an optical sensor 150, and an X-ray radiation shield 210, in accordance with some aspects of the present disclosure.

FIG. 5 is a schematic diagram illustrating an example of an X-ray tube 110 including an optical sensor 150 and a light guide 180, in accordance with some aspects of the present disclosure.

FIG. 6 is a schematic diagram illustrating an example of an X-ray tube 110 including an optical sensor 150 and a light guide 180 that provides an optical path that avoids a direct line of sight between the optical sensor 150 and the cooling fluid-filled space, in accordance with some aspects of the present disclosure.

FIG. 7 is a schematic diagram illustrating an example of an X-ray tube 110 including an optical sensor 150, a light guide 170, and an X-ray radiation shield 210, in accordance with some aspects of the present disclosure.

FIG. 8 is a schematic diagram illustrating an example of an X-ray tube 110 including an optical sensor 150, an optical window 190, and a light coupling element 220, in accordance with some aspects of the present disclosure.

FIG. 9 is a schematic diagram illustrating an example of system 300 that includes an X-ray tube 110 and one or more processors 310, in accordance with some aspects of the present disclosure.

FIG. 10 is a schematic diagram illustrating an example of a system 300 that includes an X-ray tube 110, one or more processors 310, and remote processing device 240, in accordance with some aspects of the present disclosure.

FIG. 11 is a schematic diagram illustrating an example of a system 300 that includes an X-ray tube 110 with an optical sensor 150 and a second optical sensor 150′, and one or more processors 310, in accordance with some aspects of the present disclosure.

FIG. 12 is a schematic diagram illustrating an example of a system 300 that includes an X-ray tube 110 with an optical emitter 260, and one or more processors 310, in accordance with some aspects of the present disclosure.

### DETAILED DESCRIPTION OF EMBODIMENTS

Examples of the present disclosure are provided with reference to the following description and figures. In this description, for the purposes of explanation, numerous specific details of certain examples are set forth. Reference in the specification to “an example”, “an implementation” or similar language means that a feature, structure, or characteristic described in connection with the example is included in at least that one example. It is also to be appreciated that features described in relation to one example may also be used in another example, and that all features are not necessarily duplicated in each example for the sake of brevity. For instance, features described in relation to one example of an X-ray tube, may be implemented in another example of an X-ray tube, in a corresponding manner.

In the following description, reference is made to examples of an X-ray tube. In some examples, reference is made to the use of the X-ray tube in a medical imaging system. In this regard, the medical imaging system may be a projection X-ray imaging system, or a computed tomography “CT” imaging system. However, it is to be appreciated that the use of the X-ray tube is not limited to a medical imaging system, or indeed to medical applications. For instance, unless explicitly stated, the X-ray tube may be used in a wide range of application fields, including non-destructive testing, materials characterisation, and security, for example.

In some examples described herein, reference is made to operations that are performed by one or more processors. In this regard, the operations may be implemented by a single dedicated processor, or by a single shared processor, or by a plurality of individual processors, some of which can be shared. The operations may for instance be performed by processors that are shared within a networked processing architecture such as a client/server architecture, a peer-to-peer architecture, the Internet, or the Cloud. It is also noted that the operations that are performed by one or more processors may be provided in the form of a non-transitory computer-readable storage medium including computer-readable instructions stored thereon, which, when executed by at least one processor, cause the at least one processor to perform the operations. In other words, the operations may be implemented in a computer program product. The computer program product can be provided by dedicated hardware, or hardware capable of running the software in association with appropriate software.

The explicit use of the terms “processor” or “controller” should not be interpreted as exclusively referring to hardware capable of running software, and can implicitly include, but is not limited to, digital signal processor “DSP” hardware, read only memory “ROM” for storing software, random access memory “RAM”, a non-volatile storage device, and the like. Furthermore, examples of the present disclosure can take the form of a computer program product accessible from a computer-usable storage medium, or a computer-readable storage medium, the computer program product providing program code for use by or in connection with a computer or any instruction execution system. For the purposes of this description, a computer-usable storage medium or a computer readable storage medium can be any apparatus that can comprise, store, communicate, propagate, or transport a program for use by or in connection with an instruction execution system, apparatus, or device. The medium can be an electronic, magnetic, optical, electromagnetic, infrared, or a semiconductor system or device or propagation medium. Examples of computer-readable media include semiconductor or solid state memories, magnetic tape, removable computer disks, random access memory “RAM”, read-only memory “ROM”, rigid magnetic disks and optical disks. Current examples of optical disks include compact disk-read only memory “CD-ROM”, compact disk-read/write “CD-R/W”, Blu-Ray™ and DVD. As mentioned above, there remains a need for improvements in the detection of arcing events in X-ray tubes.

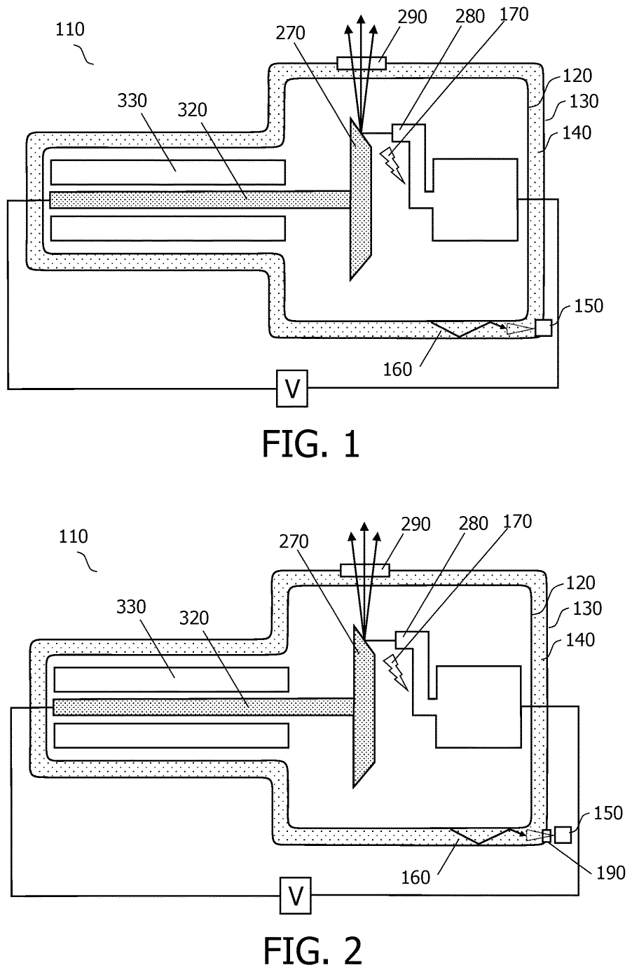

FIG. 1 is a schematic diagram illustrating an example of an X-ray tube 110 including an optical sensor 150, in accordance with some aspects of the present disclosure. With reference to FIG. 1, the X-ray tube 110 includes:
a vacuum-containing envelope 120;
a housing 130;
a cooling fluid 140; and
an optical sensor 150;

The vacuum-containing envelope 120 and the housing 130 are separated by a space, and the space is filled by the cooling fluid 140. The optical sensor 150 is arranged to detect optical arcing radiation 160 passing tangentially around the vacuum-containing envelope through the cooling fluid-filled space, and which optical arcing radiation is generated within the vacuum-containing envelope in response to an arcing event 170.

As mentioned above, some X-ray tubes include a cooling fluid-filled space between the vacuum-containing envelope and the housing. The cooling fluid is used to remove heat that is generated as a side-effect of the X-ray radiation, and which might otherwise damage the X-ray tube. The inventors have observed that optical arcing radiation that is generated within the vacuum-containing envelope, intercepts the cooling fluid-filled space between the vacuum-containing envelope and the housing. The inventors have also observed that the cooling fluid-filled space serves as a light guide that confines some of the intercepted optical arcing radiation to the cooling fluid-filled space. Some of the optical arcing radiation that is intercepted, propagates tangentially around the vacuum-containing envelope through the cooling fluid-filled space. By arranging the optical sensor such that it detects optical arcing radiation passing tangentially around the vacuum-containing envelope through the cooling fluid-filled space, it is provided that the optical sensor detects a significant amount of the optical arcing radiation. Consequently, the optical sensor has a high sensitivity to arcing events.

With reference to the example illustrated in FIG. 1, the vacuum-containing envelope 120 is formed from an optically transparent material. The vacuum-containing envelope 120, may be formed from glass, for example. In some examples, the pressure within the vacuum-containing envelope 120 may be as low as 10⁻⁸ mbar. In some examples the pressure may be in the range of approximately 10⁻⁵-10⁻⁸ mbar.

The housing 130 serves in-part to provide mechanical integrity to the vacuum-containing envelope 120. The housing 130 may also serve in-part to absorb stray X-ray radiation that is emitted from within the vacuum-containing envelope 120. The housing 130 may be formed from various materials, including metals such as steel and lead, for example. In one example, the housing is formed from steel, and the steel housing is provided with a cover that is formed from lead in order to absorb stray X-ray radiation that is emitted from within the vacuum-containing envelope 120. The housing may include an X-ray window 290 for transmitting X-ray radiation. The X-ray window 290 is formed from a material that is transparent to X-ray radiation. Various metals, such as beryllium, may be used for this purpose.

The cooling fluid 140 may be provided by various fluids. In some examples, the colling fluid includes water, and in other examples the cooling fluid includes oil. The water, or oil, may include various additives, such as (polyethylene) glycol in the case of water, for example.

The X-ray tube illustrated in FIG. 1 also includes an anode target 270 and a cathode 280. The anode target 270 and the cathode 280 are disposed within the vacuum-containing envelope 120. The anode target 270 may be formed from various materials such as molybdenum, copper, and tungsten for example. In use, the anode target is configured to emit X-ray radiation in response to the reception of electrons emitted by the cathode. In this regard, the cathode 280 is heated by a heater (not illustrated in FIG. 1), and a potential difference, V, is applied between the anode target 270 and the cathode 280. The potential difference provides an electric field that accelerates electrons that are emitted by the heated cathode 280. The accelerated electrons bombard the anode target 270, resulting in the emission of X-ray radiation. The value of the potential difference, V, depends on the desired energy of the X-ray radiation that is to be emitted by the X-ray tube 110. In the example of diagnostic medical imaging systems, X-ray radiation with an energy in the range of 30 keV-120 keV are typically used, and consequently the potential difference, V, may be in the range of approximately 30 kV to 120 kV. The electrons that are accelerated by the electric field also heat the anode target 270, and consequently the anode target 270 may reach a high temperature. Under some operating conditions, the anode target may reach a temperature of approximately 2000 degrees centigrade. In some examples, the anode target 270 is rotated. The anode is rotated in-part in order to distribute the heating of the anode target over a larger surface area. In this regard, the anode target 270 may be mechanically coupled to a motor that includes an anode rotor 320 and a stator 330, and which are configured to rotate the anode target 270. The speed of rotation of the anode target 270 may be in the order of 10,000 rpm. In other examples the anode target 270 remains static when in use, and consequently a motor is not necessary.

The X-ray tube 110 illustrated in FIG. 1 also includes an optical sensor 150. The optical sensor 150 is sensitive to optical radiation that is generated in response to an arcing event. In this regard the optical sensor 150 may be sensitive to various portions of the optical spectrum. For instance, the optical sensor 150 may be sensitive to a range of wavelengths within the visible portion of the optical spectrum and/or a range of wavelengths within the infrared portion of the optical spectrum and/or a range of wavelengths within the ultraviolet portion of the optical spectrum. The optical sensor 150 may be formed from various materials, including silicon, gallium arsenide, indium gallium arsenide indium antimonide, germanium, and so forth. The optical sensor 150 may be provided by various types of optical detectors, including a photodiode, an avalanche photodiode, a photomultiplier tube, and so forth.

As also illustrated in FIG. 1, the vacuum-containing envelope 120 and the housing 130 are separated by a space, and the space is filled by the cooling fluid 140. In some examples, the separation between the vacuum-containing envelope 120 and the housing 130 may be in the range from a fraction of a millimetre to a few centimeters.

The optical sensor 150 is arranged to detect optical arcing radiation 160 passing tangentially around the vacuum-containing envelope through the cooling fluid-filled space, and which optical arcing radiation is generated within the vacuum-containing envelope in response to an arcing event 170. In this regard, an example of an arcing event 170 within the X-ray tube is illustrated in FIG. 1. Arcing events may occur for various reasons, including as a consequence of incomplete degassing, cracks on the surface of the anode target, and material deposition on the inner surface of the vacuum-containing envelope. Arcing events may originate at various locations within the vacuum-containing envelope. Often, arcing events originate in the region between the anode target 270 and the cathode 280, as illustrated in FIG. 1. However, arcing events may also occur elsewhere within the vacuum-containing envelope.

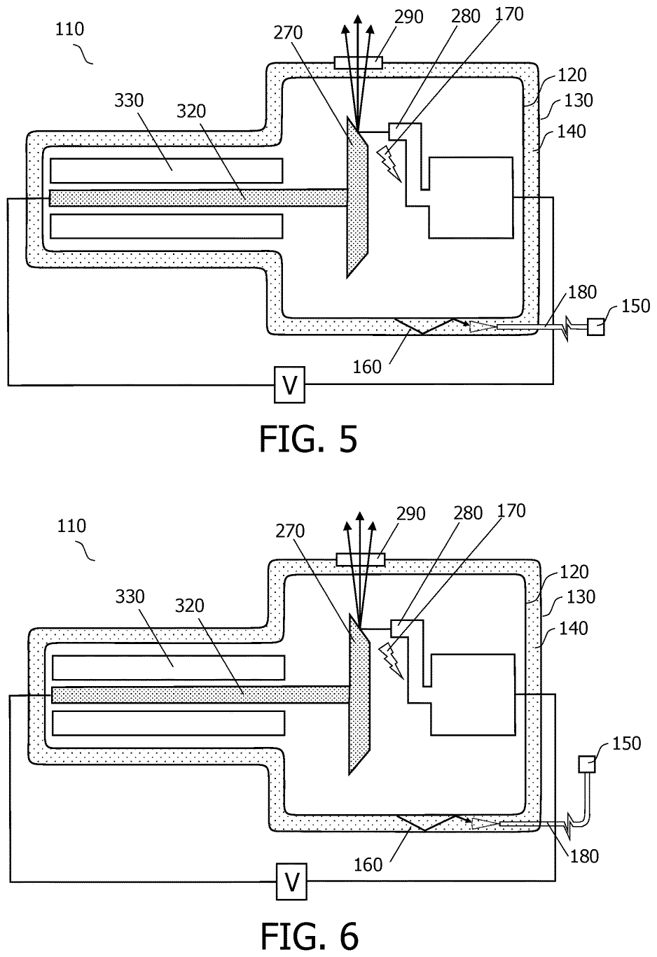

Various arrangements now are described in which the optical sensor 150 detects optical arcing radiation 160 passing tangentially around the vacuum-containing envelope through the cooling fluid-filled space. One set of arrangements that includes the optical sensor 150 is described with reference to FIG. 1-FIG. 4. Another set of arrangements that includes the optical sensor 150 and a light guide 180, is described with reference to FIG. 5-FIG. 7.

In the arrangement illustrated in FIG. 1, the optical sensor 150 is inserted into the housing such that it receives optical arcing radiation directly from the cooling fluid-filled space. The reception of optical arcing radiation by the optical sensor 150 is indicated in FIG. 1 by the conical shape coupled to the optical sensor 150 and which indicates a viewing angle of the optical sensor. In one example, the optical sensor 150 includes an optical axis along which the optical arcing radiation 160 is received. The optical axis of the optical sensor is aligned tangentially with respect to the vacuum-containing envelope 120 for detecting, with the optical sensor, the optical arcing radiation passing tangentially around the vacuum-containing envelope through the cooling fluid-filled space. The optical axis of the optical sensor may be arranged perpendicularly with respect to an optical radiation-receiving surface of the optical sensor. This facilitates the collection of the optical arcing radiation with high efficiency.

In a variation of the example illustrated in FIG. 1, the housing 130 also includes an optical window 190. The optical window 190 is configured to optically couple the cooling fluid-filled space to the optical sensor 150. This example is illustrated in FIG. 2, which is a schematic diagram illustrating an example of an X-ray tube 110 including an optical sensor 150 and an optical window 190, in accordance with some aspects of the present disclosure. The example illustrated in FIG. 2 differs from the example illustrated in FIG. 1 in that the example illustrated in FIG. 2 also includes the optical window 190. Items in FIG. 2 that have the same labels as those in FIG. 1 refer to the same item, and provide corresponding functionality. The use of an optical window 190 as illustrated in FIG. 2 has various advantages, including the simplification of the manufacturing of the X-ray tube, the provision of additional freedom in positioning and orienting the optical sensor 150, and the facilitation of its replacement.

The optical window 190 may be formed from various optically-transparent materials, including polymers, and glasses. In one example, an inner surface of the optical window includes an anti-reflection coating. The antireflection coating improves the amount of optical arcing radiation that is coupled onto the optical sensor 150. In one example, the optical window 190 is formed from a glass comprising lead. The lead in the glass acts to attenuate X-ray radiation that is generated within the vacuum-containing envelope, thereby providing shielding to the optical sensor 150, and also to nearby electrical and electronic devices.

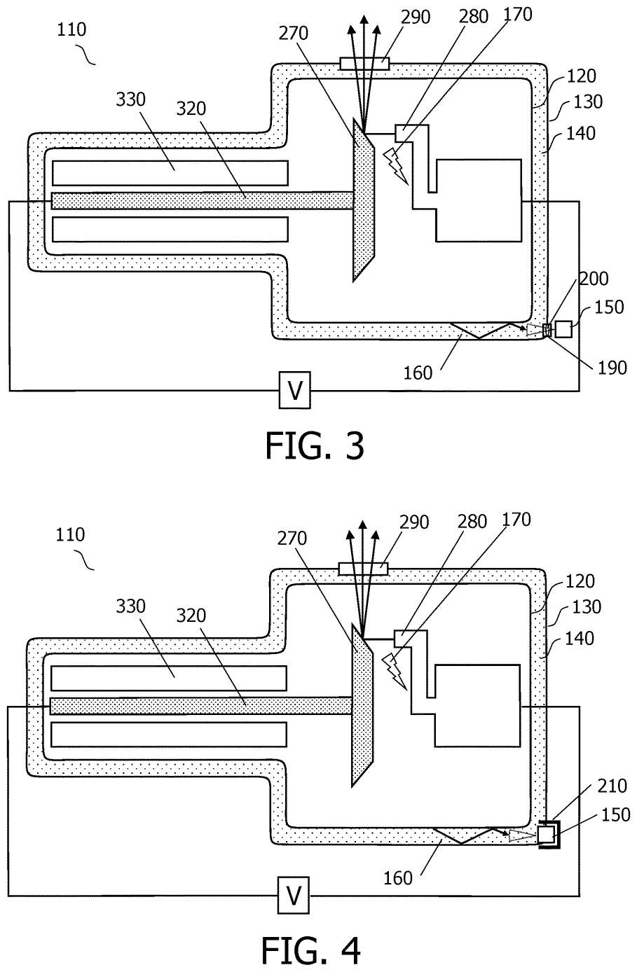

In another variation of the example illustrated in FIG. 1, the X-ray tube is provided with an optical collector 200. The optical collector is configured to concentrate optical arcing radiation 160 received from the cooling fluid-filled space onto the optical sensor 150. This example is illustrated in FIG. 3, which is a schematic diagram illustrating an example of an X-ray tube 110 including an optical sensor 150, an optical window 190, and an optical collector 200, in accordance with some aspects of the present disclosure.

The example illustrated in FIG. 3 differs from the example illustrated in FIG. 1 in that the example illustrated in FIG. 3 also includes the optical collector 200. Items in FIG. 3 that have the same labels as those in FIG. 1 refer to the same item, and provide corresponding functionality. The optical collector 200 may be provided by a lens, or an optical concentrator such as an optical cup, for example. A lens may serve as a collimator that collimates the optical arcing radiation onto the optical sensor 150. In the example illustrated in FIG. 3, an optical collector 190 is provided in combination with the optical window 180. However, it is noted that the optical collector 200 may simultaneously serve as an optical window 180. For example, if the optical collector 200 is a lens, the lens may simultaneously serve as an optical window and as an optical collector.

In another variation of the example illustrated in FIG. 1, the optical sensor 150 is provided with an X-ray radiation shield. This example is described with reference to FIG. 4, which is a schematic diagram illustrating an example of an X-ray tube 110 including an optical sensor 150, and an X-ray radiation shield 210, in accordance with some aspects of the present disclosure. The example illustrated in FIG. 4 differs from the example illustrated in FIG. 1 in that the example illustrated in FIG. 4 also includes the X-ray radiation shield 210. Items in FIG. 4 that have the same labels as those in FIG. 1 refer to the same item, and provide corresponding functionality.

In the example illustrated in FIG. 4, the X-ray radiation shield 210 is configured to shield the optical sensor 150 from X-ray radiation received from a perpendicular direction with respect to an optical radiation-receiving surface of the optical sensor. In so doing, the lifetime of the optical sensor may be improved and/or interference caused by X-ray radiation to the optical sensor may be reduced. The X-ray radiation shield may be formed from various X-ray-attenuating materials, including lead, and tungsten, for example. The X-ray radiation shield 210 may be provided with various shapes, including a flat plate, a curved plate, or in the shape of a socket, in order to shield the optical sensor 150 from X-ray radiation that is incident on the optical sensor from one or more directions.

As mentioned above, in another set of arrangements, the optical sensor 150 includes a light guide 180. The light guide 150 is configured to optically couple the cooling fluid-filled space to the optical sensor 150. This set of arrangements is described with reference to FIG. 5-FIG. 7.

FIG. 5 is a schematic diagram illustrating an example of an X-ray tube 110 including an optical sensor 150 and a light guide 180, in accordance with some aspects of the present disclosure. The use of a light guide 180 provides additional flexibility in the positioning of the optical sensor 150 with respect to the X-ray tube 110. The light guide 180 may be provided by an optical fiber, or by a light pipe, for example.

In one example, the light guide (180 comprises a distal end and an optical axis, and the optical axis at the distal end of the light guide is aligned tangentially with respect to the vacuum-containing envelope 120 for collecting, with the light guide, the optical arcing radiation 160 passing tangentially around the vacuum-containing envelope through the cooling fluid-filled space. This example facilitates the collection of the optical arcing radiation with high efficiency.

In examples in which the light guide 180 is provided by an optical fiber, improved optical coupling of the optical arcing radiation may be provided by a matching of refractive indices. In one example, the optical fiber comprises a core having a refractive index, and the cooling fluid 140 has a refractive index, and the refractive index of the core of the optical fiber is substantially equal to the refractive index of the cooling fluid. This improves the amount of optical arcing radiation that is coupled into the optical fiber from the cooling fluid. A difference between the refractive index of the optical fiber and refractive index of the cooling fluid may be in the range of ±5%, or ±10%, for example. By way of an example, the core of the optical fiber may have a refractive index of approximately 1.5, and a cooling fluid that is provided by a mixture of water and polyethylene glycol may have a refractive index of approximately 1.45, which provides a mismatch of approximately 3%. Using these values results in a value for the Fresnel reflectance at normal incidence of less than 1%.

In another example, the light guide 180 is configured to provide an optical path for the optical arcing radiation 160, and the optical path avoids a direct line of sight between the optical sensor 150 and the cooling fluid-filled space. This example is described with reference to FIG. 6, which is a schematic diagram illustrating an example of an X-ray tube 110 including an optical sensor 150 and a light guide 180 that provides an optical path that avoids a direct line of sight between the optical sensor 150 and the cooling fluid-filled space, in accordance with some aspects of the present disclosure. The example illustrated in FIG. 6 differs from the example illustrated in FIG. 5 in that the example illustrated in FIG. 6 also includes a light guide 180 that provides an optical path that avoids a direct line of sight between the optical sensor 150 and the cooling fluid-filled space. Items in FIG. 6 that have the same labels as those in FIG. 5 refer to the same item, and provide corresponding functionality.

By avoiding a direct line of sight between the optical sensor 150 and the cooling fluid-filled space, the example illustrated in FIG. 6 provides protection of the optical sensor 150 from X-ray radiation that is generated within the vacuum-containing envelope, and which might otherwise travel along the optical path between the cooling fluid-filled space and the optical sensor 150.

In the example illustrated in FIG. 6, the light guide 180 is provided by an optical fiber, and the optical path changes direction by approximately 90 degrees. However, it is to be appreciated that other changes in direction of the optical path may be used. It is also to be appreciated that a light pipe may be used to achieve the same effect. For instance, the light pipe may include a mirrored internal surface that reflects the optical arcing radiation through a bend such as that illustrated in FIG. 6. A mirror may alternatively be employed to divert light in a light pipe in order to facilitate a change in the optical path.

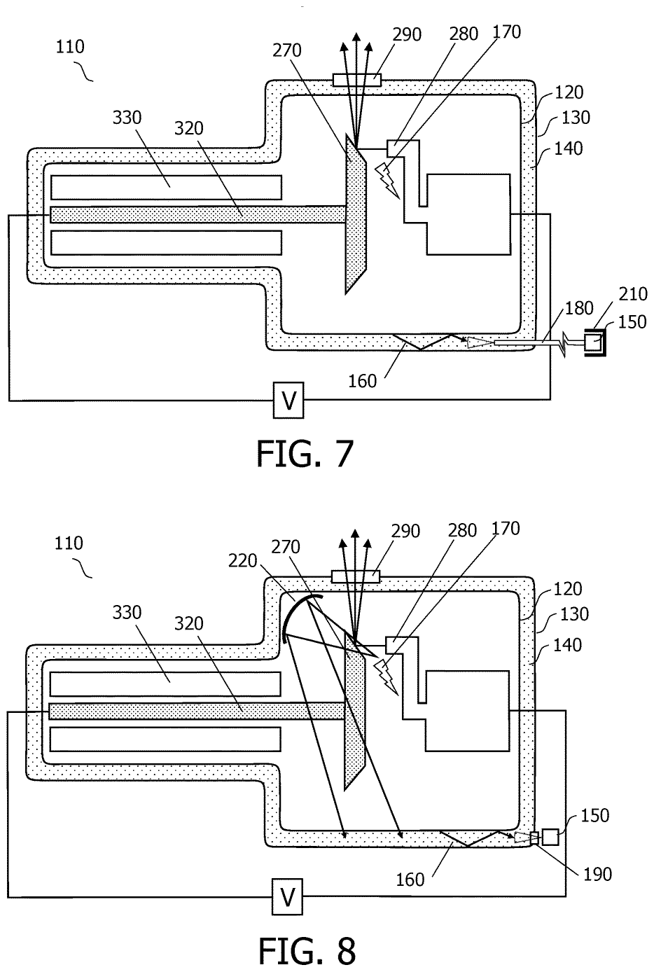

In another example, the optical sensor 150 of the arrangement illustrated in FIG. 5 is provided with an X-ray radiation shield. This example is described with reference to FIG. 7, which is a schematic diagram illustrating an example of an X-ray tube 110 including an optical sensor 150, a light guide 170, and an X-ray radiation shield 210, in accordance with some aspects of the present disclosure. The example illustrated in FIG. 7 differs from the example illustrated in FIG. 5 in that the example illustrated in FIG. 7 also includes an X-ray radiation shield 210. Items in FIG. 7 that have the same labels as those in FIG. 5 refer to the same item, and provide corresponding functionality. The X-ray radiation shield 210 illustrated in FIG. 7 may be provided in a similar manner as described above with reference to FIG. 4.

Some examples may be used with the set of arrangements described with reference to FIG. 1-FIG. 4, or with the set of arrangements described with reference to FIG. 5-FIG. 7. These examples are described below. These examples are described with reference to an X-ray tube that includes an optical sensor 150. It is, however, to be appreciated that these examples may alternatively be implemented in an X-ray tube that includes an optical sensor 150 and light guide 180.

In one example, an inner surface of the housing 130 is used to improve the amount of optical arcing radiation that is detected by the optical sensor 150. In this example, the housing 130 comprises an inner surface, and the inner surface of the housing comprises a reflective surface for confining the optical arcing radiation 160 within the housing. As an alternative to the reflective surface, the inner surface of the housing may include a metallic structured metamaterial configured to guide the optical arcing radiation 160 to the optical sensor 150. The inner surface of the housing 130 may be provided with a reflective surface by polishing the inner surface, or by coating the inner surface with a metallic layer, for example. Suitable metallic structured metamaterials that may be used for this purpose are disclosed in a document by Caligiuri, V. et al., “Metal-semiconductor-oxide extreme hyperbolic metamaterials for selectable canalization wavelength”, Journal of Physics D: Applied Physics, 49 08LT01, 2016.

In another example, the X-ray tube 110 is provided with a light coupling element 220. The light coupling element 220 is configured to couple the optical arcing radiation 160 generated within the vacuum-containing envelope 120, into the cooling fluid-filled space. The light coupling element 220 may be provided by a mirror, or a lens formed by a shape of the vacuum-containing envelope 120, or a shape of an inner surface of the housing 130. This has the effect of increasing the amount of optical arcing radiation that is detected by the optical sensor 150. This example is described with reference to FIG. 8, which is a schematic diagram illustrating an example of an X-ray tube 110 including an optical sensor 150, an optical window 190, and a light coupling element 220, in accordance with some aspects of the present disclosure. The example illustrated in FIG. 8 differs from the example illustrated in FIG. 1 in that the example illustrated in FIG. 8 also includes a light coupling element 220. Items in FIG. 8 that have the same labels as those in FIG. 1 refer to the same item, and provide corresponding functionality.

In the example illustrated in FIG. 8, the light coupling element 220 is provided by a parabolic mirror. The parabolic mirror is arranged to direct the optical arcing radiation that is generated within the vacuum-containing envelope, into the cooling fluid-filled space. The parabolic mirror illustrated in FIG. 8 increases the amount of optical arcing radiation that is detected by the optical sensor 150 by directing the optical arcing radiation into the cooling fluid-filled space, and also by simultaneously concentrating the optical arcing radiation. In alternative implementations, mirror with a different shape may be provided, or a lens may be formed by shaping the shaping the thickness of the vacuum-containing envelope 120 so as to provide a profile that is similar to a lens. Alternatively, a shape of the inner surface of the housing 130 may be used to couple the optical arcing radiation 160 that is generated within the vacuum-containing envelope 120, into the cooling fluid-filled space. For instance, the shape of the inner surface of the housing may be provided in the form of a (parabolic) mirror.

In the examples described above with reference to FIG. 1-FIG. 4, it is noted that the optical sensor 150 may be arranged at various positions around the vacuum-containing envelope. Likewise, a distal end of the light guide 180, which may be provided by an optical fiber, may also be arranged at various positions around the vacuum-containing envelope.

In one example, the optical sensor 150, or the distal end of the light guide 180, is arranged in a position that is shadowed from the deposit of evaporated material on the vacuum-containing envelope. Over time, portions of the inner surface of the vacuum-containing envelope typically become coated with materials that are evaporated from the anode target, the heater, and so forth. This risks a degradation in the sensitivity of the optical sensor 150 to arcing events. However, some portions of the inner surface of the vacuum-containing envelope remain relatively free from such deposits due to shadowing by elements within the vacuum-containing envelope. In this example, the optical sensor 150, or the distal end of the light guide 180, may be arranged in a position that is shadowed from the deposit of evaporated material on the vacuum-containing envelope. The shadowing may be provided by a portion of the anode target 270, or by a portion of the cathode 280, for example. In such an arrangement, the impact of such deposits on the sensitivity of the optical sensor 150 to arcing events is reduced.

In another example, the optical sensor 150, or the distal end of the light guide 180, is arranged in a position at which a cross sectional area of the cooling fluid-filled space in a plane that is perpendicular to a tangent around the vacuum-containing envelope, is less than a total inner surface area of the housing. This condition is satisfied at many locations around the vacuum-containing envelope in view of the dimensions of typical X-ray tubes. This arrangement has the effect of concentrating the optical arcing radiation 160 that passes tangentially around the vacuum-containing envelope through the cooling fluid-filled space, thereby increasing the power density of the optical arcing radiation that is detected by the optical sensor 150.

In another example, an inner surface of the vacuum-containing envelope 120 includes an anti-reflection coating for improving the coupling of optical arcing radiation from within the vacuum-containing envelope 120 into the cooling fluid-filled space.

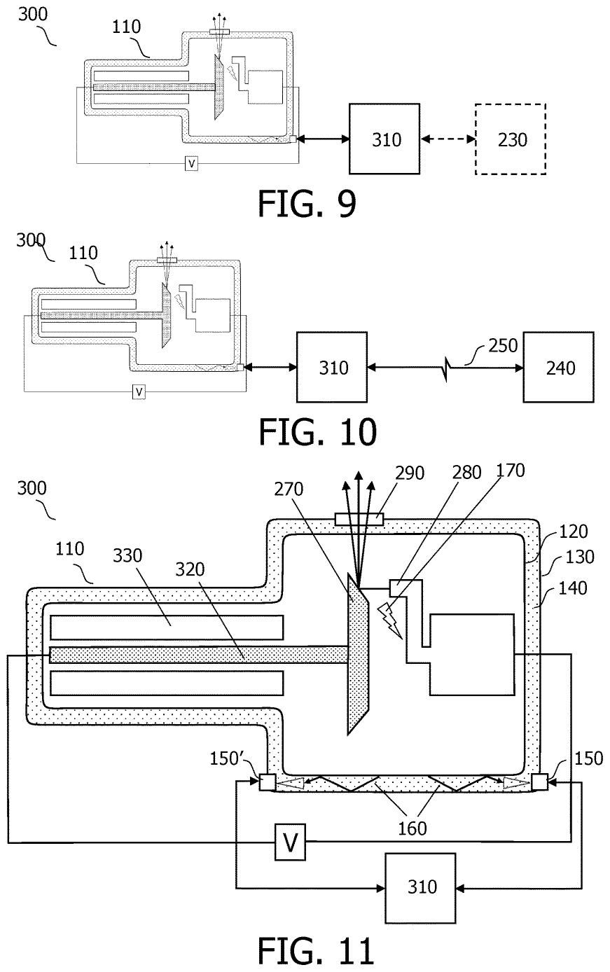

In some examples, a system is provided. The system includes an X-ray tube 110 as described in the examples above, and one or more processors 310. The one or more processors 310 perform various operations using electrical signals that are generated by the optical sensor 150 in response to the optical arcing radiation 160. The system 300 is described with reference to FIG. 9-FIG. 12.

In one example, a system 300 is provided that includes an X-ray tube 110, and one or more processors 310. The one or more processors are configured to receive electrical signals generated by the optical sensor 150 in response to the optical arcing radiation 160, and to output an indication of a detected arcing event 170 in response to the received electrical signals.

This example is described with reference to FIG. 9, which is a schematic diagram illustrating an example of system 300 that includes an X-ray tube 110 and one or more processors 310, in accordance with some aspects of the present disclosure. In general, optical radiation may be emitted from within the vacuum-containing envelope due to various heating effects, such as the heating of the anode, and due the heating of the heater. In this example, the one or more processors may determine that an arcing event has occurred based on one or more criteria. For instance, the one or more processors may determine that an arcing event has occurred if the electrical signals generated by the optical sensor 150 represent a pulse. In this regard, a pulse may be detected based on a duration for which the electrical signals exceed a predetermine threshold value. If the duration is within a range that is characteristic of an arcing event, an arcing event is deemed to have been detected. Other criteria, including for example the gradient of the electrical signals may be measured and used in addition to or instead of the detection of a pulse to determine whether an arcing event has occurred. An arcing event may be deemed to have been detected if the gradient of the electrical signals exceeds a predetermined threshold value, for example.

In this example, the indication of the detected arcing event 170 may be outputted in various ways. For example the indication may be outputted to a display 230, as illustrated in FIG. 9. By outputting such an indication, an operator may be alerted to the occurrence of an arcing event. The operator may consequently ascertain a course of action to be taken, such as for example whether a medical imaging scan needs to be repeated, or whether the X-ray tube 110 requires maintenance. An indication of the detected arcing event 170 may also be outputted in other ways. For example the indication may be outputted to a computer readable storage medium. The indication may for example be outputted to a log file associated with the system 300.

In another example, the one or more processors 310 are configured to transmit the indication of the detected arcing event 170 to a remote processing device 240 via a data communication network 250 for triggering a service work order request to verify the X-ray tube, or to perform a maintenance operation on the X-ray tube.

This example is illustrated in FIG. 10, which is a schematic diagram illustrating an example of a system 300 that includes an X-ray tube 110, one or more processors 310, and remote processing device 240, in accordance with some aspects of the present disclosure. The indication may be transmitted via the data communication network 250 using any form of data communication, including wired, optical, and wireless communication. By way of some examples, when wired or optical communication is used, the communication may take place via signals transmitted on an electrical or optical cable, and when wireless communication is used, the communication may for example be via RF or optical signals.

In another example, the system 300 includes an X-ray tube 110 that includes a second optical sensor 150′. In this example the one or more processes 310 output an indication of a detected arcing event 170 based on the electrical signals generated by the second optical sensor 150′ as well as the signals generated by the optical sensor.

This example is described with reference to FIG. 11, which is a schematic diagram illustrating an example of a system 300 that includes an X-ray tube 110 with an optical sensor 150 and a second optical sensor 150′, and one or more processors 310, in accordance with some aspects of the present disclosure.

In this example, the X-ray tube 110 comprises a second optical sensor 150′ arranged to detect optical arcing radiation 160 passing tangentially around the vacuum-containing envelope through the cooling fluid-filled space, and from a different location to the optical sensor 150. The one or more processors 310 are configured to receive electrical signals generated by the second optical sensor 150′ in response to the optical arcing radiation 160, and to output the indication of the detected arcing event 170 based on the electrical signals generated by the second optical sensor 150′.

Thus, in this example the electrical signals generated by the second optical sensor 150′, as well as the electrical signals generated by the optical sensor 150, are used to determine whether an arcing event 170 has occurred. For instance, the one or more processors 310 may output the indication of the detected arcing event 170 if the electrical signals generated by the optical sensor 150, as well as the electrical signals generated by the second optical sensor 150′, satisfy one or more of the criteria described above. This improves the certainty of the detection of an arcing event.

In another example, an origin of the arcing event is determined. In this example, the one or more processors 310 are further configured to determine an origin of the arcing event 170 within the vacuum-containing envelope 120, based on the electrical signals generated by the optical sensor 150 and the electrical signals generated by the second optical sensor 150′. The origin of the arcing event 170 may be determined based on a relative magnitude of the electrical signals generated by the optical sensor 150 and the second optical sensor 150′, for example. In addition to the second optical sensor 150′, one or more additional optical sensors may also be disposed in different locations for detecting optical arcing radiation 160 passing tangentially around the vacuum-containing envelope through the cooling fluid-filled space, and used in the same manner. The electrical signals generated by these additional optical sensors may also be used to determine the origin of the arcing event 170.

In another example, the one or more processors 310 are used to compensate for ageing. Over time, a sensitivity of the optical sensor 150 may degrade. This may occur in-part due to the reception of stray X-ray radiation that is emitted by the X-ray tube 110. Such stray X-ray radiation may also affect the transmission of an optical fibre coupling the optical sensor 150 to the cooling fluid-filled space. Over time, the transmission of the cooling fluid 140 in the cooling fluid-filled space may also change due to aging. Similarly, over time the optical transmission of the vacuum-containing envelope 120 may be reduced by the deposit of evaporated material on an inner surface of the envelope 120, as described above. If ageing in such components is not corrected, the electrical signals that are generated by the optical sensor 150 in response to an arcing event may diminish over time.

In this example, the one or more processors 310 are configured to apply a correction to the detected electrical signals for compensating for the effect of ageing on at least one of: optical sensor 150, an optical fiber coupling the optical sensor 150 to the cooling fluid-filled space, the cooling fluid 140, and an optical transmission of the vacuum-containing envelope 120.

The compensation for aging that is provided in accordance with this example facilitates a more accurate detection of arcing events over time. Compensation for such ageing effects may be provided by applying an aging model to the electrical signals generated by the optical sensor 150. The ageing model may predict a change in the performance of the component over time. Parameters for the ageing model may be determined empirically from measured values of the performance of the component, for example.

In another example, the optical sensor 150 is configured to generate electrical signals corresponding to optical arcing radiation 160 detected within each of a plurality of different optical wavelength intervals. In this example, the one or more processors 310 are configured to identify a type of the arcing event 160, or to determine a temperature of the anode target 270, or to perform an optical absorption measurement of the vacuum within the vacuum-containing envelope 120, based on an analysis of the electrical signals corresponding to optical arcing radiation 160 detected within a plurality of the optical wavelength intervals.

In this example, the optical sensor 150 may be configured as a spectrometer. For instance the optical sensor 150 may be provided with a plurality of detector elements wherein each detector element is sensitive to a different optical wavelength interval. This may be achieved by applying filters with different spectral bandwidths to the detector elements. Alternatively, a diffraction grating or a prism may be used to spatially separate the optical spectrum of the optical arcing radiation 160 such that different intervals of the optical spectrum are detected by different detector elements. In one example, the optical sensor is configured to perform a Raman spectral analysis. A classification of the type of arcing event may be performed by comparing the spectrum that is detected by the optical sensor 150 in response to an arcing event, with manually classified spectra that are generated from empirical measurements of the spectra for different types of arcing events, for example. A temperature of the anode target 270 may also be determined in a similar manner based on empirical measurements of the temperature and their corresponding spectra. An optical absorption measurement of the vacuum within the vacuum-containing envelope 120 may be performed by measuring the detected spectra.

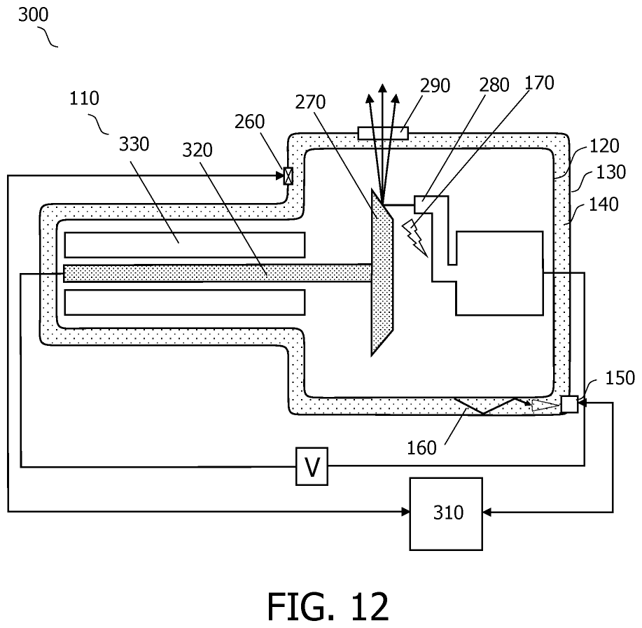

In another example, the X-ray tube is provided with an optical emitter 260. The optical emitter 260 is used to calibrate the optical path of the optical arcing radiation, or to detect vibration of the x-ray tube. This example is described with reference to FIG. 12, which is a schematic diagram illustrating an example of a system 300 that includes an X-ray tube 110 with an optical emitter 260, and one or more processors 310, in accordance with some aspects of the present disclosure.

In this example, the X-ray tube comprises an optical emitter 260, and the optical emitter is optically coupled to at least one of: an interior of the vacuum-containing envelope 120, and the cooling fluid-filled space. The optical sensor 150 is configured to generate electrical signals in response to a detection of optical radiation emitted by the optical emitter 260. The one or more processors 310 are configured to: perform at least one of the following based on the electrical signals generated by the optical sensor 150 in response to the detection of optical radiation emitted by the optical emitter 260:
perform a calibration of the optical path of the optical arcing radiation 160 generated in response to the arcing event 160; and
detect a vibration of the X-ray tube 110.

In this example, the path between the optical emitter 260 and the optical sensor 150 serves as a reference optical path. The optical path of the optical arcing radiation 160 may be calibrated by measuring reference electrical signals that are generated by the optical sensor 150 in response to the emission of optical radiation by the optical emitter 260. The calibration may be performed by subsequently calculating a ratio between the subsequent electrical signals that are generated by the optical sensor 150, to the reference electrical signals. The calibration may alternatively be performed by subtracting the reference electrical signals from the subsequent electrical signals that are generated by the optical sensor 150.

The aforementioned calibration procedure may be performed periodically in order to compensate for changes in the transmission of the optical path with effects such as the deposition of material on the inner surface of the vacuum-containing envelope 120, and also changes in optical transmission of the cooling fluid-filled space.

In this example, vibration of the X-ray tube may be detected by measuring temporal changes in the electrical signals generated by the optical sensor 150 in response to the detection of optical radiation emitted by the optical emitter 260. Vibration may cause such changes due to relative movement between the optical emitter 260 and the optical sensor 150.

In this example, the optical emitter 260 may be optically coupled to the interior of the vacuum-containing envelope 120 or to the cooling fluid-filled space using the same techniques as described above in relation to the optical sensor 150. The optical emitter 260 may be provided by various types of optical sources, including for example a light emitting diode “LED”, a laser, and a filament lamp. The optical emitter may emit optical radiation in one or more wavelength intervals in the ultraviolet, or visible, or infrared portion of the optical spectrum.

In another example, a second optical emitter is provided, and the calibration of the optical path, or the detection of a vibration of the X-ray tube 110, is performed based further on the electrical signals generated in response to a detection of the optical radiation emitted by the second optical emitter.

In this example, the system 300 includes a second optical emitter. The second optical emitter is optically coupled to at least one of: the interior of the vacuum-containing envelope 120, and the cooling fluid-filled space. The second optical emitter is optically coupled to the interior of the vacuum-containing envelope 120, or the cooling fluid-filled space, respectively, at a different location to the optical emitter 260. The one or more processors 310 are configured to perform the calibration of the optical path for the optical arcing radiation 160 generated in response to the arcing event 160, or detect a vibration of the X-ray tube 110, based further on the electrical signals generated in response to a detection of the optical radiation emitted by the second optical emitter.

In this example, the second optical emitter provides a second reference optical path, and consequently second reference electrical signals for calibrating the optical path, or for detecting vibration. The reference electrical signals and the second reference electrical signals may be fitted to a model in order to improve the calibration of the optical path, and thereby improve the sensitivity of the system to vibration, respectively. For instance, if the optical path, and second reference optical path overlap one another, corresponding changes may be expected to both optical paths over time, and therefore the transmission detected along one optical path may be used to confirm that the transmission along the other optical path is genuine.

An emumerated list of Examples of the present disclosure is provided below:

Example 1. An X-ray tube (110) comprising:
a vacuum-containing envelope (120);
a housing (130);
a cooling fluid (140); and
an optical sensor (150);
wherein the vacuum-containing envelope (120) and the housing (130) are separated by a space, and the space is filled by the cooling fluid (140); and
wherein the optical sensor (150) is arranged to detect optical arcing radiation (160) passing tangentially around the vacuum-containing envelope through the cooling fluid-filled space, and which optical arcing radiation is generated within the vacuum-containing envelope in response to an arcing event (170).

Example 2. The X-ray tube according to Example 1, further comprising a light guide (180); and
wherein the light guide is configured to optically couple the cooling fluid-filled space to the optical sensor (150).

Example 3. The X-ray tube according to Example 2, wherein the light guide (180) is provided by an optical fiber, or a light pipe.

Example 4. The X-ray tube according to Example 2 or Example 3, wherein the light guide (180) is configured to provide an optical path for the optical arcing radiation (160); and
wherein the optical path avoids a direct line of sight between the optical sensor (150) and the cooling fluid-filled space.

Example 5. The X-ray tube according to Example 3, wherein the light guide (180) is provided by an optical fiber; and
wherein the optical fiber has a refractive index; and
wherein the cooling fluid (140) has a refractive index; and
wherein the refractive index of the optical fiber is substantially equal to the refractive index of the cooling fluid.

Example 6. The X-ray tube according to Example 1, wherein the housing (130) comprises an optical window (190); and
wherein the optical window is configured to optically couple the cooling fluid-filled space to the optical sensor (150).

Example 7. The X-ray tube according to Example 6, wherein optical window (190) is formed from a glass comprising lead.

Example 8. The X-ray tube according to Example 6 or Example 7, further comprising an optical collector (200); and
wherein the optical collector is configured to concentrate optical arcing radiation (160) received from the cooling fluid-filled space onto the optical sensor (150).

Example 9. The X-ray tube according to Example 1 or Example 2, wherein the optical sensor (150) comprises an X-ray radiation shield (210); and
wherein the X-ray radiation shield (210) is configured to shield the optical sensor (150) from X-ray radiation received from a perpendicular direction with respect to an optical radiation-receiving surface of the optical sensor.

Example 10. The X-ray tube according to Example 1, wherein the housing (130) comprises an inner and
wherein the inner surface of the housing comprises a reflective surface for confining the optical arcing radiation (160) within the housing; or
wherein the inner surface of the housing comprises a metallic structured metamaterial configured to guide the optical arcing radiation (160) to the optical sensor (150).

Example 11. The X-ray tube according to Example 1, further comprising a light coupling element (220);
wherein the light coupling element is configured to couple the optical arcing radiation (160) generated within the vacuum-containing envelope (120), into the cooling fluid-filled space; and wherein the light coupling element is provided by:
a mirror; or
a lens formed by a shape of the vacuum-containing envelope (120); or
a shape of an inner surface of the housing (130).

Example 12. A system (300) comprising the X-ray tube (110) according to any one of Examples 1 11, and one or more processors (310);
wherein the one or more processors are configured to receive electrical signals generated by the optical sensor (150) in response to the optical arcing radiation (160), and to output an indication of a detected arcing event (170) in response to the received electrical signals.

Example 13. The system according to Example 12, wherein one or more processors (310) are configured to apply a correction to the detected electrical signals for compensating for the effect of ageing on at least one of: optical sensor (150), an optical fiber coupling the optical sensor (150) to the cooling fluid-filled space, the cooling fluid (140), and an optical transmission of the vacuum-containing envelope (120).

Example 14. The system according to Example 12, wherein the optical sensor (150) is configured to generate electrical signals corresponding to optical arcing radiation (160) detected within each of a plurality of different optical wavelength intervals; and
wherein the one or more processors (310) are configured to perform at least one of the following based on an analysis of the electrical signals corresponding to optical arcing radiation (160) detected within a plurality of the optical wavelength intervals:
identify a type of the arcing event (160); and
determine a temperature of the anode target (270);
perform an optical absorption measurement of the vacuum within the vacuum-containing envelope (120).

Example 15. The system according to any one of Examples 12-14, wherein the X-ray tube further comprises an optical emitter (260); and
wherein the optical emitter is optically coupled to at least one of: an interior of the vacuum-containing envelope (120), and the cooling fluid-filled space; and
wherein the optical sensor (150) is configured to generate electrical signals in response to a detection of optical radiation emitted by the optical emitter (260); and
wherein the one or more processors (310) are configured to perform at least one of the following based on the electrical signals generated by the optical sensor (150) in response to the detection of optical radiation emitted by the optical emitter (260):
perform a calibration of the optical path of the optical arcing radiation (160) generated in response to the arcing event (160); and
detect a vibration of the X-ray tube (110).

The above examples are to be understood as illustrative of the present disclosure, and not restrictive. Further examples are also contemplated. For instance, any of the example X-ray tubes described above may be included in the system 300. It is to be understood that a feature described in relation to any one example may be used alone, or in combination with other described features, and may be used in combination with one or more features of another of the examples, or a combination of other examples. Furthermore, equivalents and modifications not described above may also be employed without departing from the scope of the invention, which is defined in the accompanying claims. In the claims, the word “comprising” does not exclude other elements or operations, and the indefinite article “a” or “an” does not exclude a plurality. The mere fact that certain features are recited in mutually different dependent claims does not indicate that a combination of these features cannot be used to advantage. Any reference signs in the claims should not be construed as limiting their scope.

1. An X-ray tube comprising:
a vacuum-containing envelope;
a housing;
a cooling fluid; and
an optical sensor;
wherein the vacuum-containing envelope and the housing are separated by a space, and the space is filled by the cooling fluid; and
wherein the optical sensor is arranged to detect optical arcing radiation passing tangentially around the vacuum-containing envelope through the cooling fluid-filled space, and which optical arcing radiation is generated within the vacuum-containing envelope in response to an arcing event; and
wherein the X-ray tube further comprises a light guide and the light guide is configured to optically couple the cooling fluid-filled space to the optical sensor; or
wherein the housing comprises an optical window, and the optical window is configured to optically couple the cooling fluid-filled space to the optical sensor.

2. The X-ray tube according to claim 1, wherein the light guide is provided by an optical fiber, or a light pipe.

3. The X-ray tube according to claim 1, wherein the light guide is configured to provide an optical path for the optical arcing radiation; and
wherein the optical path avoids a direct line of sight between the optical sensor and the cooling fluid-filled space.

4. The X-ray tube according to claim 2, wherein the light guide is provided by an optical fiber; and
wherein the optical fiber comprises a core having a refractive index; and
wherein the cooling fluid has a refractive index; and
wherein the refractive index of the core of the optical fiber is substantially equal to the refractive index of the cooling fluid.

5. The X-ray tube according to claim 1, wherein optical window is formed from a glass comprising lead.

6. The X-ray tube according to claim 1, further comprising an optical collector; and
wherein the optical collector is configured to concentrate optical arcing radiation received from the cooling fluid-filled space onto the optical sensor.

7. The X-ray tube according to claim 1, wherein the optical sensor comprises an X-ray radiation shield; and
wherein the X-ray radiation shield is configured to shield the optical sensor from X-ray radiation received from a perpendicular direction with respect to an optical radiation-receiving surface of the optical sensor.

8. The X-ray tube according to claim 1, wherein the housing comprises an inner surface; and
wherein the inner surface of the housing comprises a reflective surface for confining the optical arcing radiation within the housing; or
wherein the inner surface of the housing comprises a metallic structured metamaterial configured to guide the optical arcing radiation to the optical sensor.

9. The X-ray tube according to claim 1, further comprising a light coupling element;
wherein the light coupling element is configured to couple the optical arcing radiation generated within the vacuum-containing envelope, into the cooling fluid-filled space; and
wherein the light coupling element is provided by:
a mirror; or
a lens formed by a shape of the vacuum-containing envelope; or
a shape of an inner surface of the housing.

10. A system comprising the X-ray tube according to claim 1, and one or more processors;
wherein the one or more processors are configured to receive electrical signals generated by the optical sensor in response to the optical arcing radiation, and to output an indication of a detected arcing event in response to the received electrical signals.

11. The system according to claim 10, wherein one or more processors are configured to apply a correction to the detected electrical signals for compensating for the effect of ageing on at least one of: the optical sensor, an optical fiber coupling the optical sensor to the cooling fluid-filled space, the cooling fluid, and an optical transmission of the vacuum-containing envelope.

12. The system according to claim 10, wherein the optical sensor is configured to generate electrical signals corresponding to optical arcing radiation detected within each of a plurality of different optical wavelength intervals; and
wherein the one or more processors are configured to perform at least one of the following based on an analysis of the electrical signals corresponding to optical arcing radiation detected within a plurality of the optical wavelength intervals:
identify a type of the arcing event; and
determine a temperature of the anode target;
perform an optical absorption measurement of the vacuum within the vacuum-containing envelope.

13. The system according to claim 10, wherein the one or more processors are further configured transmit the indication of the detected arcing event to a remote processing device via a data communication network for triggering a service work order request to verify the X-ray tube, or to perform a maintenance operation on the X-ray tube.

14. The system according to claim 10, wherein the X-ray tube further comprises a second optical sensor arranged to detect optical arcing radiation passing tangentially around the vacuum-containing envelope through the cooling fluid-filled space, and from a different location to the optical sensor; and
wherein the one or more processors are further configured to receive electrical signals generated by the second optical sensor in response to the optical arcing radiation, and to output the indication of the detected arcing event based on the electrical signals generated by the second optical sensor.

15. The system according to claim 14, wherein the one or more processors are further configured to determine an origin of the arcing event within the vacuum-containing envelope, based on the electrical signals generated by the optical sensor and the electrical signals generated by the second optical sensor.

16. The system according to claim 10, wherein the X-ray tube further comprises an optical emitter; and
wherein the optical emitter is optically coupled to at least one of: an interior of the vacuum-containing envelope and the cooling fluid-filled space; and
wherein the optical sensor is configured to generate electrical signals in response to a detection of optical radiation emitted by the optical emitter; and
wherein the one or more processors are configured to perform at least one of the following based on the electrical signals generated by the optical sensor in response to the detection of optical radiation emitted by the optical emitter:
perform a calibration of the optical path of the optical arcing radiation generated in response to the arcing event; and
detect a vibration of the X-ray tube.

17. The system according to claim 16, further comprising a second optical emitter, and wherein the second optical emitter is optically coupled to at least one of: the interior of the vacuum-containing envelope, and the cooling fluid-filled space, and wherein the second optical emitter is optically coupled to the interior of the vacuum-containing envelope, or the cooling fluid-filled space, respectively, at a different location to the optical emitter; and
wherein the one or more processors are further configured to perform the calibration of the optical path for the optical arcing radiation generated in response to the arcing event, or detect a vibration of the X-ray tube, based further on the electrical signals generated in response to a detection of the optical radiation emitted by the second optical emitter.
